(19) United States
(12) Patent Application Publication
(10) Pub. No.: US 2008/0303787 A1
(43) Pub. Date: Dec. 11, 2008

(54) Touch Screen Apparatus And Methods

(76) Inventor: Yu "Brian" Zheng, Walnut, CA (US)

Correspondence Address: HELLER EHRMAN LLP, 4350 LA JOLLA VILLAGE DRIVE #700, 7TH FLOOR, SAN DIEGO, CA, 92122, US

(21) Appl. No.: 12/124,914

(22) Filed: May 21, 2008

Related U.S. Application Data
(63) Continuation-in-part of application No. 11/957,001, filed on Dec. 14, 2007.
Application No. 11/957,001 is a continuation-in-part of application No. 11/828,124, filed on Jul. 25, 2007.
Application No. 11/828,124 is a continuation-in-part of application No. 11/726,454, filed on Mar. 22, 2007.
Application No. 11/726,454 is a continuation-in-part of application No. 11/540,369, filed on Sep. 29, 2006.
Application No. 11/540,369 is a continuation-in-part of application No. 11/368,300, filed on Mar. 3, 2006.
Application No. 11/368,300 is a continuation-in-part of application No. 11/255,852, filed on Oct. 21, 2005.

(51) Int. Cl. G09G 5/00

(52) U.S. Cl. 345/156

(57) ABSTRACT

A touch screen computing apparatus, methods, and software product are provided. In one embodiment, an the computing apparatus provides a plurality of regions on a touch screen that are mapped to functions. In some embodiments, the regions include a keyboard region, a game control region, a mouse region and a stylus region. In some embodiments, the regions are configurable by the processor and mapped with different functionality. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### CROSS-REFERENCE TO RELATED APPLICATIONS

This application is a continuation-in-part of co-pending U.S. patent application Ser. No. 11/957,001 filed Dec. 14, 2007, which is a continuation in part of U.S. patent application Ser. No. 11/828,124, filed Jul. 25, 2007, which is a continuation-in-part of U.S. patent application Ser. No. 11/726,454, filed Mar. 22, 2007, which is a continuation-in-part of co-pending U.S. patent application Ser. No. 11/540,369, filed Sep. 29, 2006, which is a continuation-in-part of co-pending U.S. patent application Ser. No. 11/368,300, filed Mar. 3, 2006, which is a continuation-in-part of co-pending U.S. patent application Ser. No. 11/255,852, filed Oct. 21, 2005. Priority is claimed to these applications and they are incorporated by reference in their entirety.

This application is additionally related to U.S. patent application Ser. No. ______, entitled “Online Interactive Game System and Methods”, attorney docket number 44435-0010; and U.S. patent application Ser. No. ______, entitled “Universal Toy Controller System and Methods”, attorney docket nr. 44435-0011 both of this are filed contemporaneously herewith.

### FIELD OF THE INVENTION

The present invention generally relates to computing and entertainment system controllers. More particularly, the invention concerns universal control methods, and apparatus for computing and entertainment systems.

### BACKGROUND OF THE INVENTION

Users are increasing demanding more sophistication in computing and entertainment devices. With this demand ever increasing the electronics industry has responded with a wide range of offerings. Entertainment systems typically include online games, played on a personal computer, or in some instances, can comprise stand alone game consoles. One limitation that users experience moving between environments is that most game controllers are not interchangeable between gaming systems. Additionally, a user comfortable with one type of game controller may not enjoy the same experience when changing to another system may not have the same experience they would on a system with a different controller. Further, many game consoles are like personal computers in that the game controllers use an industry standard interface.

Another limitation inherent in the industry is that after a user is familiar with a specific game, the game becomes rather routine. Unless a mechanism is provided that allows the user experience to change over time, a user may loose interest and not receive the same entertainment experience. Further, touch screen technologies are advancing to the point where controllers could become more functional.

Since a number of games are played online it is additionally important to be able to interface with a computer using a common apparatus. Currently computing apparatus input devices, such as keyboards, mice, and stylus sensitive pads can take up a significant amount of space in a users office and serve essentially one function. This is a limitation of the current technologies employed. It would therefore be advantageous to provide a universal controller for gaming systems and for computing apparatus with enhanced capabilities.

### SUMMARY OF THE INVENTION

Embodiments of the present invention provide a computing and entertainment controllers, methods and computer software products. An exemplary embodiment of a provided entertainment system includes at least one hand held game controller with a touch screen and a number of accelerometers. The accelerometers indicating the movement of the hand held game controller. The controllers are configured with wireless communications transceivers allowing them to communicate to a base station. The system further includes a base station that communicates with the hand held controllers. The base station is further configured with a connector suitable for connection to an accessory box and a second connector suitable for connection to a computing device. The entertainment system optionally includes an accessory box with a connecter sufficient for connecting the accessory box to the base station.

In some embodiments, the accessory box is configured to allow additional functionality to be imparted to game play. The entertainment system further includes an online game portal hosted on a server on the network. One embodiment provides a method of interactive play. In this embodiment a signal is communicated from at least one hand held game controller to a base station. Like the above embodiment, the hand held controllers contain touch screens and accelerometers. In this embodiment, the base station additionally receives a communications signal from an accessory box. The base station communicates a command to a computing device that is connected to a server over a network. The computing device sends commands, and other information to the server. The server communicates signals back to the computing device which enable game play on the computing device.

Another exemplary embodiment of the present invention provides a computer software product. The software product is in the form of a computer readable medium. The medium contains processor executable instructions that, when executed by a processor configure a computing apparatus to receive a first communications signal from a base station. This first communications signal includes information received from at least one hand held game controller. The game controller, like the above controllers include a touch screen interface and a number of accelerometers. The configuration additionally includes a configuration to send a second communications signal to a server on a network, the server hosting an online game portal and to receive a third communications signal from the server on the network which enables game play on the computing device, the game play related to a game on the online game portal.

A still further provided embodiment is a computing device accessory that includes a housing, a touch sensitive display that is mounted on the housing, a communications transceiver, and a memory contained within the housing and communicating with the touch sensitive display, the memory containing instructions that, when executed by a processor configure the accessory to illuminate discrete regions on the display, the regions comprising: a keyboard region, a stylus sensitive region, and a mouse region.

Another embodiment provides a computing apparatus that includes a processor, a memory, a touch sensitive display and a storage media the storage media containing a set of processor executable instructions sufficient that, when executed by the processor, configure the computing apparatus to illuminate discrete regions on the display, the regions comprising: a keyboard region, a stylus sensitive region, and a mouse region.

Another exemplary embodiment provides a method of providing interaction with a computing apparatus. In this method the computing apparatus is configured to illuminate discrete regions on a touch sensitive display. The touch sensitive display is mounted on a housing and the housing contains a memory. Some of the discrete regions include a keyboard region, a stylus sensitive region, and a mouse region.

A further provided embodiment includes a computer implemented method that includes providing a computing apparatus, the computing apparatus contains a processor, a memory; and a touch sensitive display. The computing apparatus is configured to illuminate discrete regions on the display, the regions including a keyboard region, a stylus sensitive region, and a mouse region. An additional provided embodiment includes a computer software product. The computer software product including a machine readable media. In this embodiment, the machine readable media contains instructions that when executed by a processor illuminate discrete regions on a touch sensitive display. The discrete regions include a keyboard region, a stylus sensitive region, and a mouse region.

One provided embodiment is a universal game controller system for use with a variety of game consoles. This system includes a game controller which includes a touch screen interface and a first communications transceiver. The system additionally includes a base station; having a second communications transceiver that is configured to communicate with the first transceiver, and a communications port. The communications port is operable to connect the base station to a game console. A further provided embodiment includes a method of enabling game play on a game controller. This method includes communicating a signal from a universal game controller. In this embodiment the universal game controller is configured for use with a variety of game consoles. The game controller includes a touch screen interface and a first communications transceiver. The method further includes receiving the signal at a base station. The base station includes a second communications transceiver which is configured to communicate with the first transceiver, and a communications port operable to connect the base station to a game console. The method further includes communicating a signal from the base station to the game console.

Further provided embodiments include an online entertainment system and methods. In an exemplary method, a software module is provided on a server. The software module includes an application program interface that allows a game programmer to specify a controller mapping. The software module then generates a mapping file which is stored on the server and associated with the game. Once a user selects a game to be played on a remote computer, the server transmits the mapping file to the user's computer. The mapping file, when installed on the user's computer, maps signals received from a universal controller to actions within the selected game.

A still further embodiment provides an entertainment system for providing an interactive experience to a user. The entertainment system includes a server containing a software module. The software module contains an application program interface which allows a game programmer specify a mapping of controller actions to game actions. Based on the mapping, the software module creates a mapping file that is stored on the server and associated with the game. When a user selects a game the associated mapping file is sent to the local computer and installed. When signals are received from a universal controller the information is mapped to actions within the selected game.

An even further embodiment provides a computing apparatus that contains a processor, a memory, and a storage medium. The storage medium includes a set of processor executable instructions that, when executed by the processor configure the computing apparatus to act as a server in an entertainment system. The instructions further configure the server to provide a software module with an application program interface that allows a game programmer to specify a controller mapping. The server is further configured to generate a mapping file for each game and store the mapping file on the server. When a particular game is selected by a user, the appropriate mapping file is transmitted to the user's computer across a network. The mapping file is then installed on the user's computer and when a signal is received from a universal controller, the information contained within the signal is mapped to the game.

### BRIEF DESCRIPTION OF THE DRAWINGS

Various embodiments of the present invention taught herein are illustrated by way of example, and not by way of limitation, in the figures of the accompanying drawings, in which:

FIG. 1 illustrates a base station device consistent with various provided embodiments;

FIG. 2 illustrates an embodiment of a provided entertainment system;

FIG. 3 illustrates a feature of various provided embodiments;

FIG. 4 illustrates a feature of various provided embodiments;

FIG. 5 is an illustration of the flow of a provided method;

FIG. 6 is an illustration of a still further provided method;

FIG. 7 is an illustration of a computing apparatus and computer software product consistent with various provided embodiments;

FIG. 8 is an illustration of an accessory box consistent with various provided embodiments; and

FIG. 9 illustrates an entertainment system consistent with various provided embodiments;

FIG. 10 illustrates another entertainment system consistent with various provided embodiments;

FIG. 11 illustrates a universal controller consistent with various provided embodiments;

FIG. 12 illustrates a computing apparatus consistent with various provided embodiments;

FIG. 13 illustrates the flow of a provided embodiment;

FIG. 14 illustrates the flow of a provided embodiment;

FIG. 15 illustrates the flow of a provided embodiment;

FIG. 16 illustrates the flow of a provided embodiment;

FIG. 17 illustrates a universal tablet controller consistent with various provided embodiments;

FIG. 18 illustrates another embodiment of a provided entertainment system;

FIG. 19 illustrates the flow of a provided method;

FIG. 20 illustrates the flow of another provided method;

FIG. 21 illustrates the flow of a further provided method;

FIG. 22 illustrates the flow of yet another provided method;

FIG. 23 illustrates an embodiment of a user interface;

FIG. 24 illustrates an embodiment of a exemplary universal controller;

FIG. 25 illustrates the flow of another provided method; and

FIGS. 26 (a)-(h) illustrate various embodiments of a provided computing apparatus.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. While this invention is capable of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. Descriptions of well known components, methods and/or processing techniques are omitted so as to not unnecessarily obscure the invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Embodiments of the present invention provide systems, methods and apparatus for universal control of entertainment or computing systems. As is know in the art there are a number of manufacturers of gaming consoles each with different hand held controllers. In some instances a user may be confused by the differences in controllers and may not have the same experience when moving from one console type to another. Some embodiments of the present invention are directed at overcoming that difficulty by providing a had-held controller and system that may interoperate across platforms. Additionally, in some embodiments, the games may reside on a server on a network and the user may play the games on a computing apparatus like a personal computer. Further, some provided embodiments include a computing apparatus accessory which integrates a multiplicity of input devices into a novel, and in some instances reconfigurable device.

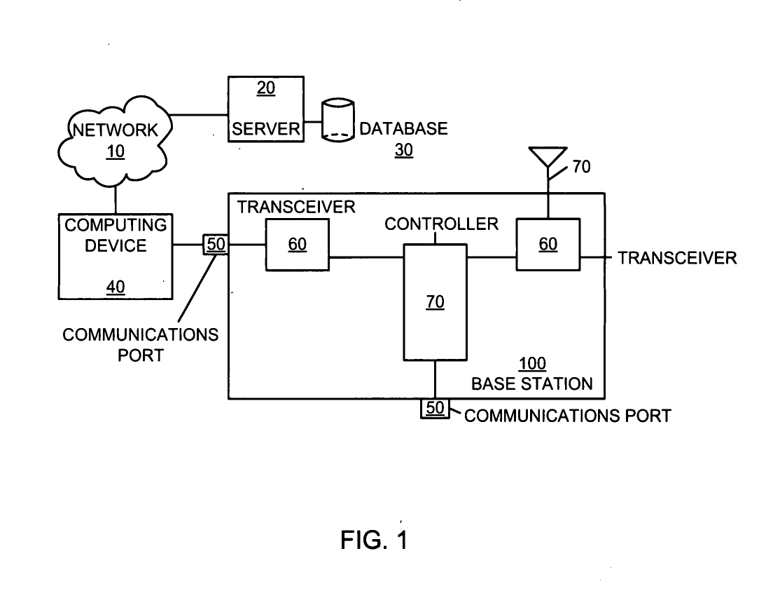

One embodiment of a base station 100 is illustrated in FIG. 1. In this embodiment, base station 100 comprises a first communications port 50 for connecting base station 100 to a computing device 40. As illustrated, computing device 40, is connected to a network 10, like the Internet, and further connected to server 20 containing database 30. As illustrated, communications port 50 is a wired port such as a Universal Serial Bus or Ethernet port, but as in known in the art may be a wireless communications port. In some embodiments, base station 100 additionally includes a second communications port 50 suitable for communications with an accessory box (not shown). Base station 100 additionally includes controller 70, a plurality of communications transceivers 60 and in some instances an antenna 70. As is known in the art all communications can be through either wired or wireless media and the illustrated depictions in FIG. 1 are exemplars.

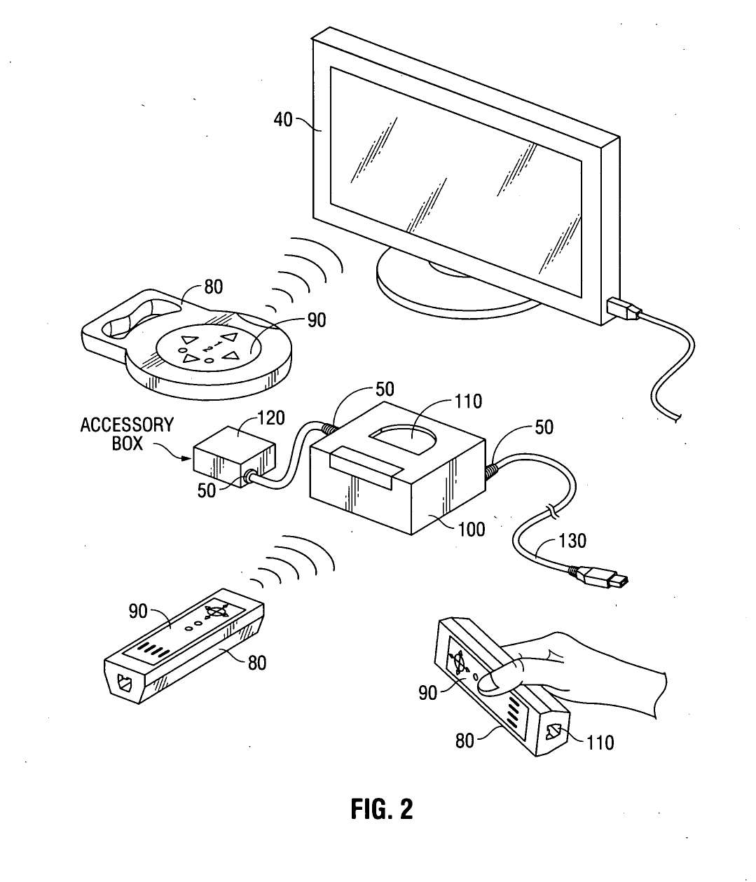

FIG. 2 illustrates an entertainment system consistent with various provided embodiments. The system includes at least one hand held game controller 80 containing a plurality of accelerometers (not shown). Each of the hand held game controller 80 includes a touch screen interface 90. In some embodiments, tough screen interface contains a number of controls sufficient to control game play. In one embodiment, touch screen 90 includes a plurality of lights which “back light” the controls indicating a control a user should take. In other embodiments, touch screen interface 80 contains depressions or “dimples” indicating the controls. In other embodiments, touch screen interface 80 contains raised portions or “buttons” indicating the controls. In still further embodiments, touch screen 80 contains regions of “textured” material indicating controls. In an exemplary embodiment, the “textured” material is “plexi-glass”, glass, or plastic that has been manufactured to provide a textured feel. Other materials that provide a distinct tactile feel are additionally known in the art and may be used to practice the invention.

Hand held controllers 80 further include a communications transceiver allowing for communication with base station 100 in a wireless format. Exemplary communications transceivers that may be used to practice embodiments of the present invention include but are not limited to optical transceivers, radio frequency transceivers, infrared transceivers, BLUETOOTH transceivers (BLUETOOTH is a trademark of the Bluetooth Special Interest Group), RFID transceivers, frequency hopping radio frequency transceivers, and ultra wideband transceiver. Hand held controllers 80 additionally include a plurality of accelerometers, such as orientation accelerometers, motion accelerometers, and acceleration accelerometers which provide data related to the position and movement of hand held controllers 80.

As discussed above, base station 10 includes a like communications transceiver to enable communications with hand held controllers 80. Base station 100 additionally includes a first connector or communications port 50 sufficient to connect base station 100 to computing apparatus 40 (shown here as a monitor). In some embodiments, base station 100 additionally includes a second connector, or port 50 sufficient to connect base station 100 to accessory box 120. Accessory box 120 likewise includes connector 50, and associated electronics enabling communications with base station 100. Exemplary connectors include but are not limited to Universal Serial Bus connectors, FireWire connectors, twisted pair connectors, phone line connectors, and wired medium connectors.

In some embodiments (not shown), connectors 50 are connected to additional communications components such as antennas, optical emitters, and optical detectors. In these embodiments, base station 100 includes an additional communications transceiver such as an optical transceiver, a radio frequency transceiver, an infrared transceiver, a Bluetooth transceiver, a RFID transceiver, a frequency hopping radio frequency transceiver, and an ultra wideband transceiver enabling wireless communications between accessory box 120, base station 100 and computing apparatus 40.

In an exemplary embodiment, base station 100 is configured to route data and commands from and between computing device 40, hand held controllers 80, and accessory box 120. As mere exemplars, this routing may take the form of receiving communications signals from the hand held devices 80 and forwarding the data contained within these signals to computing device 40. In other embodiments, the routing may provide for receiving data from accessory box 120 and sending data to computing device 40. The routed data may include but is not limited to data from at least one of the plurality of accelerometers, and data from the touch screen interface and data from accessory box enabling additional functionality to the entertainment system. In another embodiment, hand held controllers 80 contain a battery recharging port 110. A similar recharging port 110 is provided on base station 100 allowing for the recharge of the hand held controllers' batteries when not in use.

One feature of this embodiment is that the computing device 40 is in communication with 20 server on the network 10. The server hosts a game portal which stores information related to the games, information related to users, and in some embodiments, access information. When a user desires to play a specific game, the computing device may determine from accessory box 120 if the user is allowed to access the specific game. Once the computing device retrieves information on which games a user can access it sends this data to the online game portal. On the server the access data is verified and access is granted to the particular game the user desires to play.

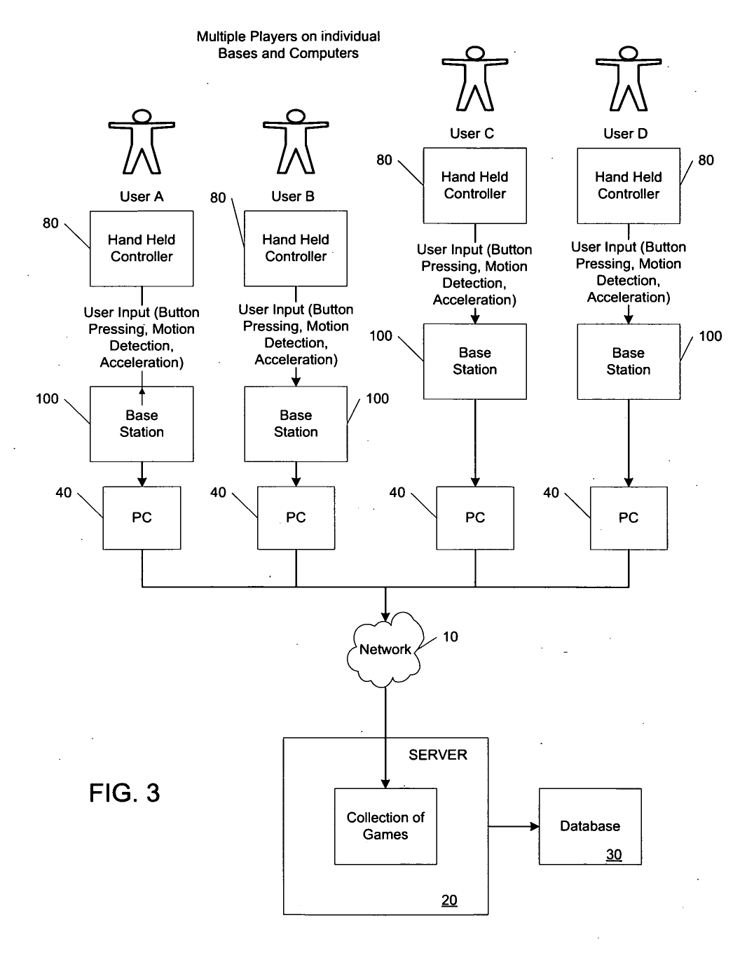

Another feature of various embodiments is illustrated in FIG. 3 which shows a configuration allowing multiple players to participate in a common game. As this illustration depicts, users A-D can use independent entertainment systems to play a common game. Each user A-D interfaces with a hand held controller 80. The hand held controllers send user input information to base stations 100, which route this information to computing apparatuses 40 (shown here as Personal Computers “PCs”). Computing apparatuses 40 are in communication with server 20 across network 10. As illustrated, server 20 is in further communication with database 30. In some embodiments, database 30 may be located on server 20, in other embodiments, database 30 is located on another computing device 40 on network 10. In this environment, game play is served to each of the computing devices 40 from server 20 allowing users A-D to interact with the game through the use of their entertainment system.

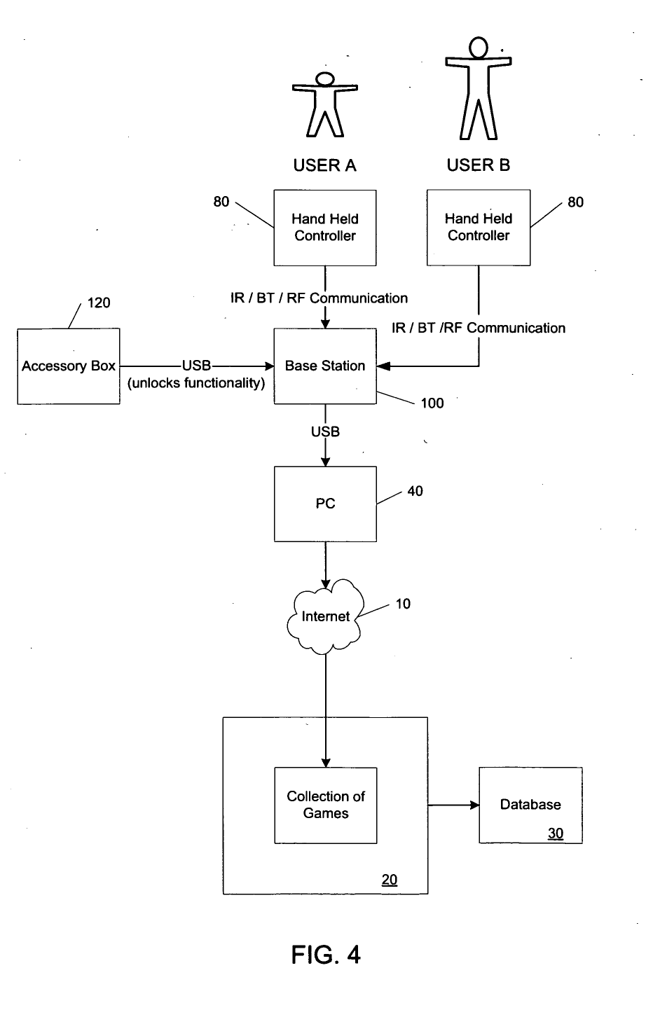

FIG. 4 illustrates another feature of various embodiments. In this illustration a configuration is shown where two users (A and B) are supported on a single entertainment system. In this illustration, User A and User B each interact with the entertainment system through the use of hand held controllers 80. The controllers communicate user interactions to base station 100. Base station 100 routs this interaction information to computing device 40 which uses the information for game play. Computing device 40 further communicates the information to server 20 across network 10. As in the previously described system, server 20 is in communication with database 30.

One further feature is illustrated in FIG. 4. The addition of accessory box 120 allows for additional functionality, such as new games, to be unlocked on the system. In this embodiment, requests for new functionality cause computing apparatus to communicate with accessory box 120 and retrieve access information. The access information is then verified on database 30. If access to the new functionality is grated, server 20 sends the additional functionality to computing device 40.

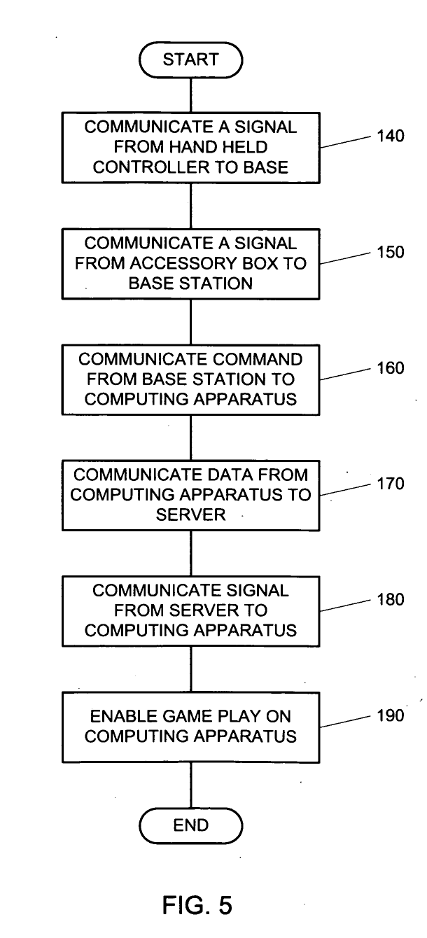

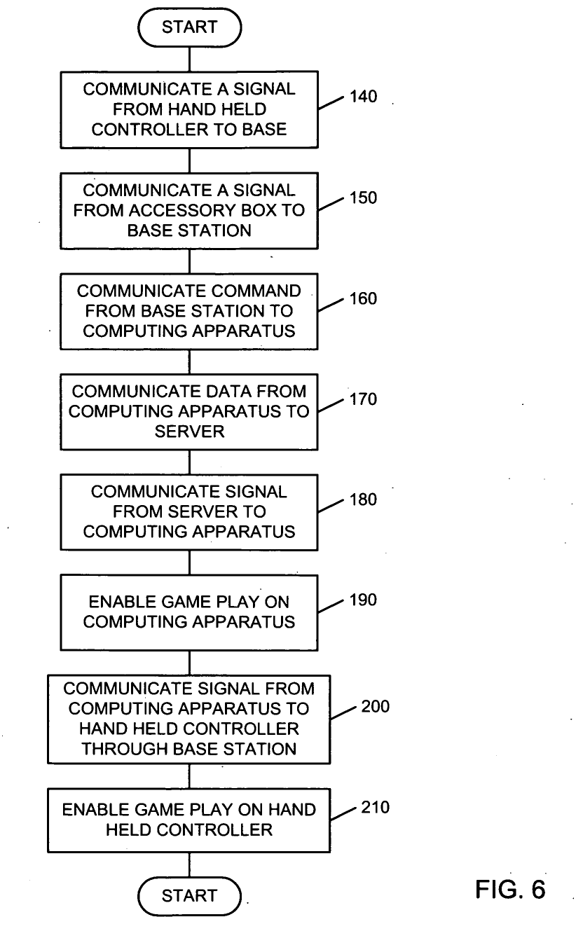

FIGS. 5 and 6 illustrate embodiments of provided methods. In FIG. 5 flow begins in block 140 where a communications signal is communicated from a hand held controller 80 to a base station 100. As described above, this signal may contain information from a plurality of accelerometers and inputs from a user through a touch screen. Further, this signal is typically communicated wirelessly through the use of wireless transceivers (optical or radio frequency). Flow continues to block 150 where a communication signal is sent from accessory box 120 to the base station 100. As described above, this signal may contain data or other information, such as commands, to unlock functionality on the system. In some embodiments, this signal is sent through wired media connectors, in other embodiments, this signal is sent wirelessly. Flow continues to block 160 where a command is sent from the base station to a computing apparatus 40. In block 170 computing apparatus 40 communicates data to server 20 on network 10. Flow continues to block 180 where server 20 sends a communication to computing apparatus 40 across network 10. In block 190, game play is enabled on computing apparatus 40.

FIG. 6 illustrates a further embodiment where the flow is the same for blocks 140-190. In block 200 a signal is communicated from computing apparatus 40 to hand held controllers 80 through base station 100 and in block 210 game play is enabled on hand held controllers 80. In some embodiments, the enablement of game play on hand held controllers 80 comprises the illumination of lights corresponding to controls on the hand held controllers 80.

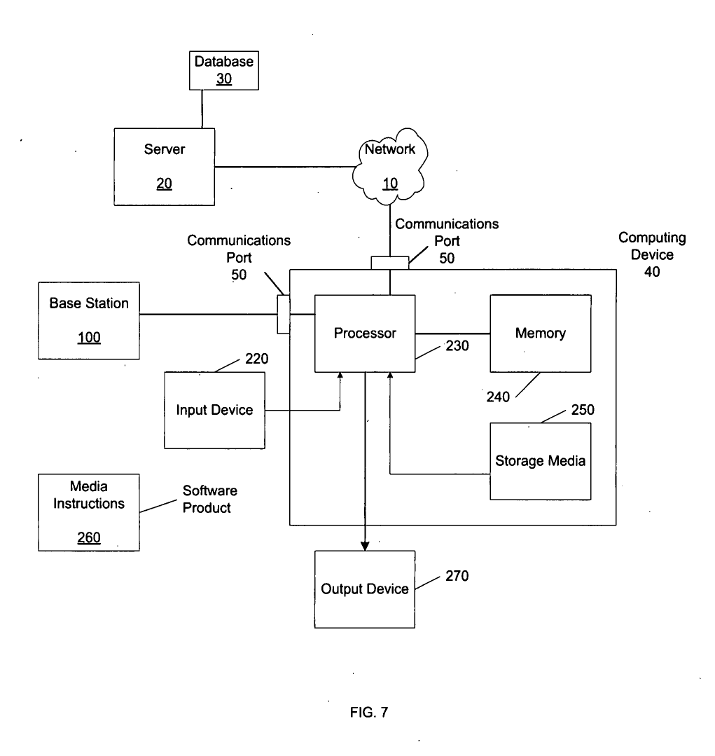

FIG. 7 illustrates a computing device 40 and computer software product 260 consistent with various provided embodiments. Computing device 40 comprises processor 230, memory 240, storage media 250, input device 220, a plurality of communications ports 50 and output device 270. As is known in the art, a number of other components are typically found within a computing device that have been omitted for convenience. As described above, one communications port 50 provides a path for communication with base station 100 and another provides a path for communication with server 20 across network 10. Exemplary input devices 220 that are suitable to receive computer software product 260 include but are not limited to CD ROM drives, DVD Rom drives, optical drives magnetic drives, and the like. Computer software product 260 comprises a computing apparatus readable medium containing a set of processor 230 executable instructions that, when executed by processor 230 configure computing device 40 to execute the methods described above. In one embodiment, computer readable media comprises a hard drive located on server 20 and executable instructions sufficient to configure computing device 40 are downloaded from network 10. In some embodiments, executable instructions are located on database 30 across network 10. As described above, database 30 may be located on server 20 or alternatively, on another computing device 40 on network 10.

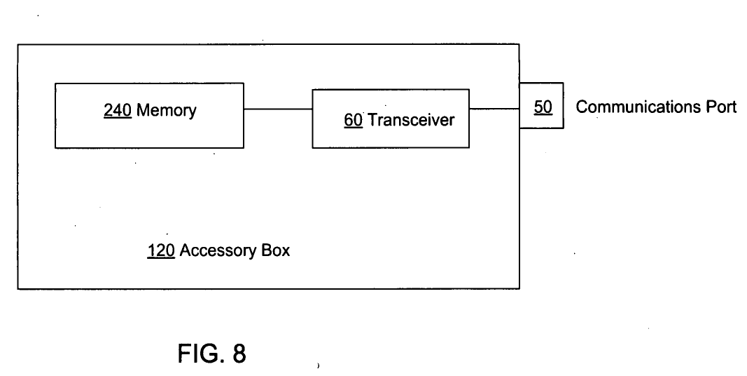

An exemplary embodiment of an accessory box 120 is illustrated in FIG. 8. In this embodiment, accessory box 120 comprises a memory 240, a communications transceiver 60 and a communications port 50. As discussed above, accessory box 120, in some embodiments imparts additional functionality to games being played. This functionality may be revealing “secret” rooms, additional weapons, or other features within a game. In some embodiments, additional games are “unlocked” with the use of accessory box 120. Memory 240 may include volatile or non-volatile memory elements. In one embodiment, codes stored on memory 240 may be sent to base station 100 unlocking the additional functionality. In some embodiments accomplishments during game play cause server 20 to send additional codes for storage in memory 240 on accessory box 120. These embodiments allow a user to experience different gaming as their level of accomplishment increases. In other embodiments purchases made online cause server 20 to send additional codes to accessory box 120.

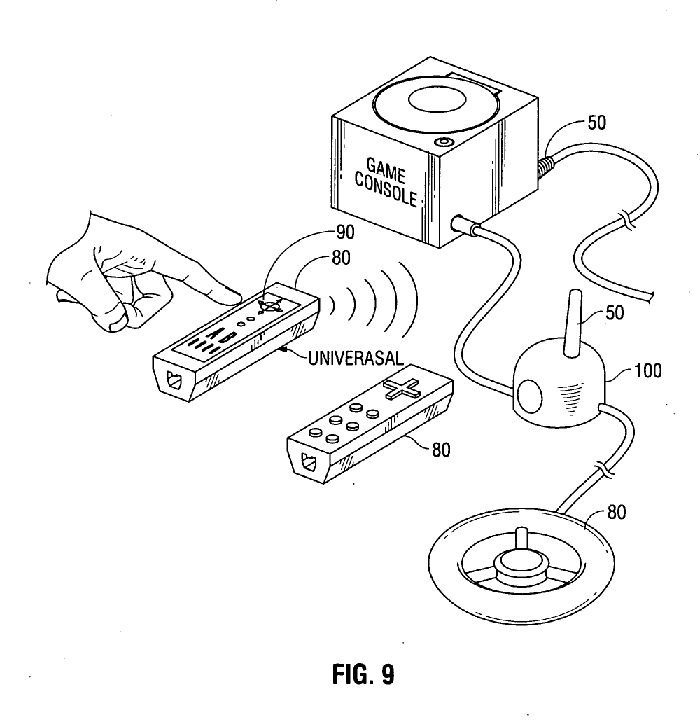

FIG. 9 illustrates embodiments where universal controllers interact with game consoles instead of a computing device 40. As is known in the art there are many manufacturers of game consoles and each manufacturer may provide different controllers for interaction. Many of these consoles provide for controller connection through a Universal Serial Bus (USB) or like connection. In the illustrated embodiment hand held controller 80, as described above, contains touch sensitive display 90. In this embodiment, hand held controller 80 communicates with base station 100 through either a wireless or wired connection. Base station 100 communicates with a game console. Stated differently, base station 100 receives control signals from handheld controller 80 and communicates them the control data to the game console through its communications port.

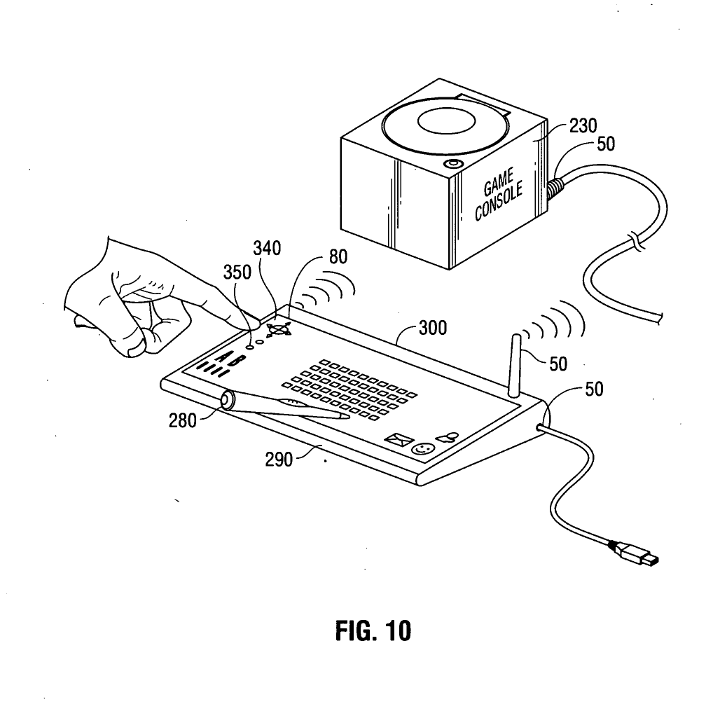

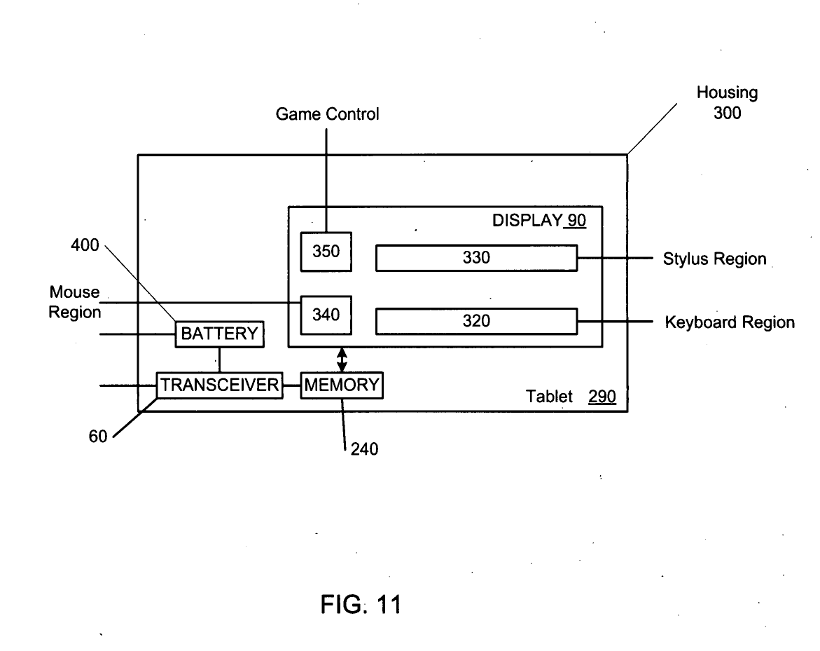

Another provided embodiment of a universal controller is illustrated in FIG. 10. In this embodiment, the controller is tablet 290. In this embodiment touch screen 90 is contained within housing 300. As illustrated it contains a plurality of discrete regions that are mapped with different functionality and in some embodiments, may be illuminated with various features and controls. Various embodiments of tablet 290 include regions for illumination of a keyboard, a section for interaction with stylus 280, a mouse control region 340 and in some instances a specific game control region 350. As illustrated, tablet 290 may communicate with the game console through a wireless media or in some embodiments through communications port 50. FIG. 11 illustrates some exemplary functional contents of tablet 290. In this embodiment, tablet 290 contains touch sensitive display 90 with an exemplary number of discrete regions that could include a game control region 350, a mouse control region 340 a keyboard region 320 a stylus sensitive region 330. In this embodiment, tablet 290 additionally includes memory 240 and a communications transceiver 60. In some embodiments, tablet 290 is battery powered and include battery 400. In a number of these embodiments, power is received from communications port 50, such as a USB port, (not shown) and can be used to power tablet 290 and recharge battery 400. In other embodiment table 290 may be powered by a plug-in power cable (not shown). In other embodiments, tablet 290 includes a processor configured to map various functionality to the regions of tablet 290. In other embodiments, mapping is accomplished by an external computing apparatus connected to and communicating with transceiver 60.

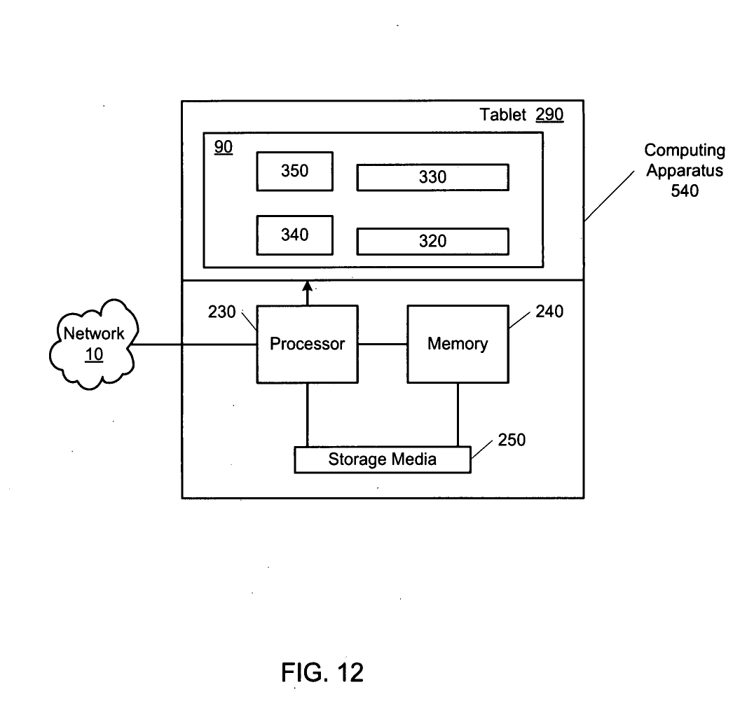

An embodiment of a provided computing apparatus 540 is illustrated in FIG. 12. This embodiment includes tablet 290 touch sensitive display 90 processor 230, memory 240, and storage media 250. In some embodiments computing apparatus 540 is configured to communicate with network 10. As illustrated, touch sensitive screen 90 includes discrete sections which are mapped with functionality. As in other embodiments, these regions include a keyboard region 320, a stylus sensitive region 330, a mouse control region 340, and in some embodiments game control section 350. Mapping, in one embodiment includes designating a set of pixels on touch sensitive display 90 and associating them with a specific character. In one embodiment, the mapping of a keyboard to keyboard region includes storing a character in memory 240 with a range of pixel locations associated with that character. In an exemplary embodiment, the character is from the American Standard Code for Information Interchange (ASCII). Other character code sets are known in the art and may be used to practice the current invention. Once mapped, a user striking a “character” on keyboard section causes a lookup in memory 240 for the associated character, the character is then read from memory 240 and transmitted by transceiver 60 (FIG. 11) or in an embodiment where tablet 240 is embedded in computing apparatus 540 the character is utilized in the manner consistent with normal usage.

In like manner, user interaction with stylus sensitive region 330, mouse control region 340, and in some embodiments game control region 350 generate data that may be captured, or recorded, and in embodiments similar to the one illustrated in FIG. 11, the data is then transmitted by transceiver 60. In embodiments where tablet 290 is embedded into computing apparatus 540, illustrated in FIG. 12, data captured from these regions is used in the manner consistent with normal usage.

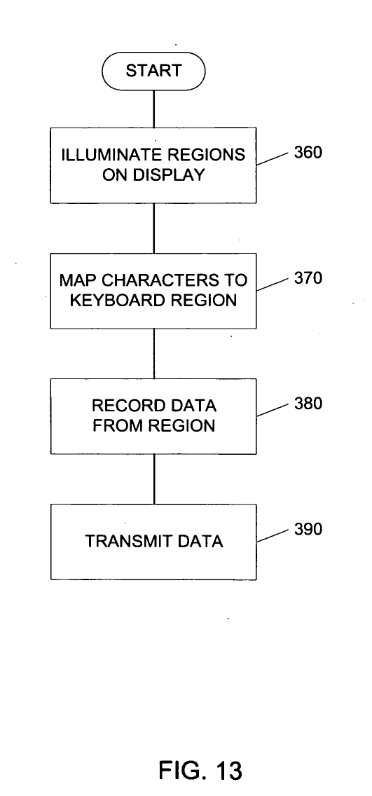

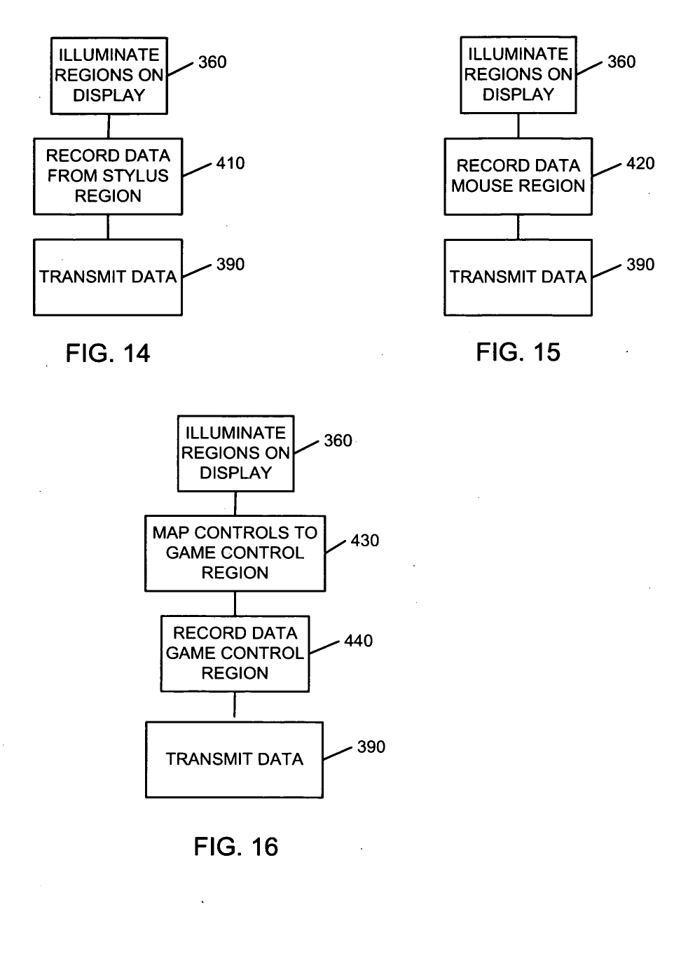

FIG. 13 illustrates an exemplary embodiment of a provided method. In this embodiment, flow begins in block 360 where discrete regions of touch sensitive display are illuminated. As discussed above these regions can include a keyboard region, a stylus sensitive region, a mouse control region and in some embodiments, a game control region. Other regions may be utilized and illuminated as well. Flow continues to block 370 where a character set is mapped to the keyboard region. Flow then continues to block 380 where data is recorded from a user interaction with the keyboard region and in embodiments like those described in FIG. 11, in block 380 the data is transmitted from tablet 290. FIG. 14 illustrates the flow of another exemplary method. In this embodiment, flow begins in block 360 where discrete regions of a touch sensitive display are illuminated. In block 410 data from the stylus region is recorded and in embodiments like those described in FIG. 11, in block 380 the data is transmitted from tablet 290. FIG. 15 illustrates a further embodiment of a provided method. In this method, flow begins in block 360 where regions are illuminated on the display. Flow continues to block 420 where data associated with the mouse control region is captured or recorded and in embodiments like those described in FIG. 11, in block 380 the data is transmitted from tablet 290. In similar manner the embodiment illustrated in FIG. 16 begins with block 360 where regions of the display are illuminated. In block 430 game controls are mapped to a game control region. In block 440 data is recorded or otherwise captured from the game control region and in embodiments like those described in FIG. 11, in block 380 the data is transmitted from tablet 290.

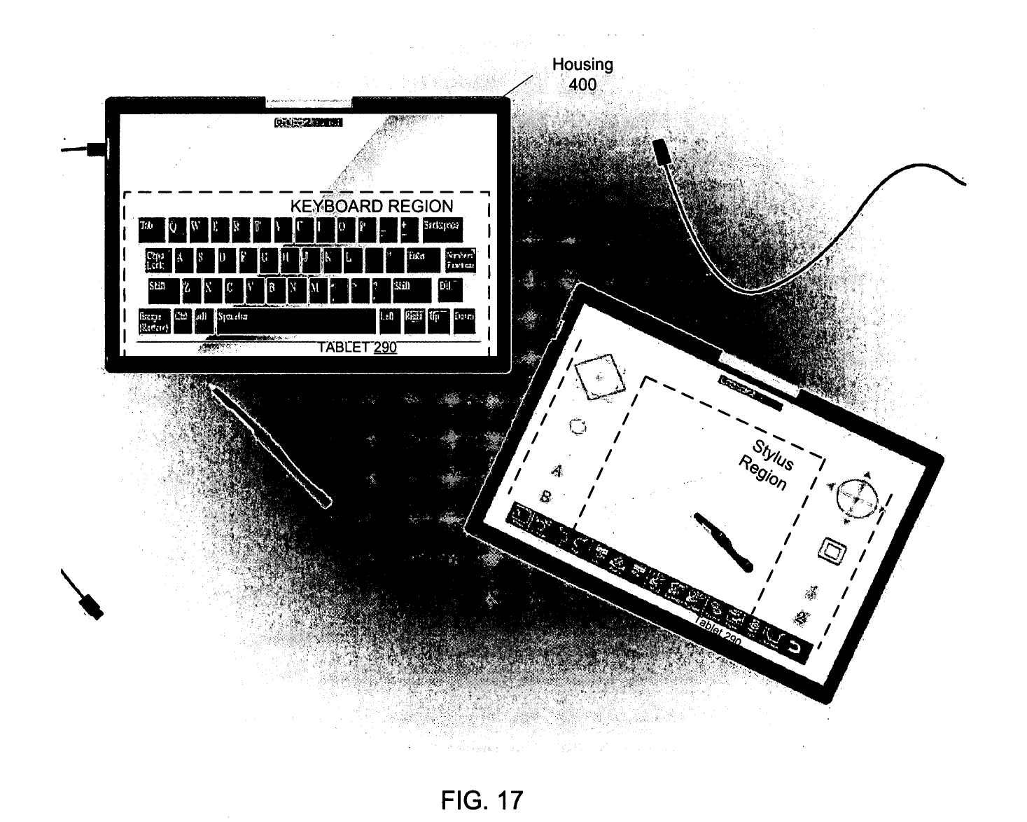

A further illustration of an integrated universal controller in the form of a tablet 290 is provided in FIG. 17. This illustrates a dynamic reconfiguration of tablet 290. In this embodiment, regions of tablet 290 can me remapped from one function to another. For example, as illustrated, at one period of time, a region of tablet 290 may be illuminated and mapped as a keyboard region and at another time the same region may be illuminated as a stylus region.

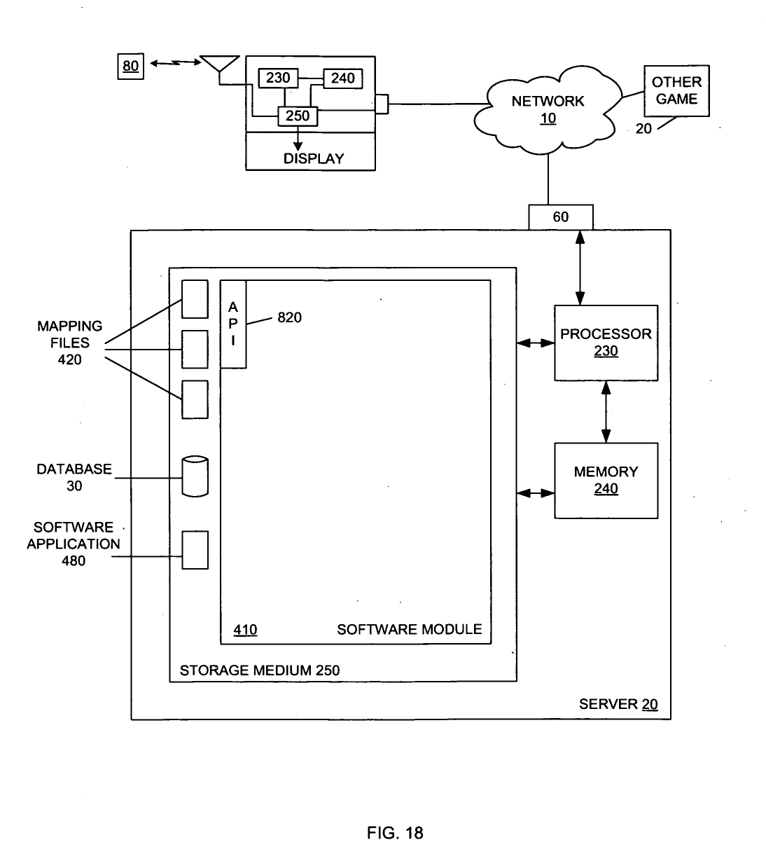

Turning now to FIG. 18, an exemplary entertainment system is illustrated. Components of the entertainment system include server 20, communicating with computing apparatus 540 across network 10. Computing apparatus is additionally communicating with universal controller 80. Universal controller 80, illustrated in some embodiments takes to form of a tablet, or stick controller, but some embodiments of the present invention are not limited to those particular configurations. As illustrated, server 20 contains processor 230, memory 240 and storage media 250 and network interface 60. Additionally, computing apparatus and server 20 may be communicating with an additional server 20 where other games may be stored. Contained within storage medium 250 is software module 410, database 30, software application 480 and in some embodiments, mapping files 420. As illustrated software module 410 contains Application Program Interface (API) 820. As is known in the art, software module 410 may be written in a number of programming languages, such as C, C++, or JAVA™. Additionally, it may be a compiled module, compiled with any number of compilers, or it could comprise a scripts, such as a JAVA™ script or pearl script, or an applet written in JAVA.

In an exemplary embodiment, server 20 hosts a web portal and additionally contains a number of web pages that can be sent to a remote computing apparatus 540. In one embodiment, a user computer communicates with server 20 through the web portal. Server 20 sends software application 480 to remote computing apparatus 540 for initialization of game play. As illustrated, some embodiments include games stored on database 30 while others additionally include remote 3^{rd} party games hosted on remote server 20. Computing apparatus 540 additionally includes display 430 where game play is graphically depicted.

API 820 allows game programmers to write games and custom interfaces for universal controller 80. Through the use of API 820 a programmer may specify which actions of universal controller 80 will map to which game play actions. In this manner, a new game programmer only need to interact with API 820 to ensure that a gamer using a universal controller 80 with computing apparatus 540 is able to play the new game. In some embodiments this is independent of where the game is actually stored. Interacting with API 820 a game programmer specifies which physical actions with universal controller 80 will map to which actions within the new game. Once complete software module 410 generates a mapping file 420. In some embodiments, mapping files 420 are text files that can be read by computing apparatus 540, in other embodiments, mapping files are scripts, such as a JAVA™ script, in other embodiments, mapping file 420 may be compiled into a Dynamic Linked Library (dll) file and loaded into memory when software application 480 executes on remote computing apparatus 430.

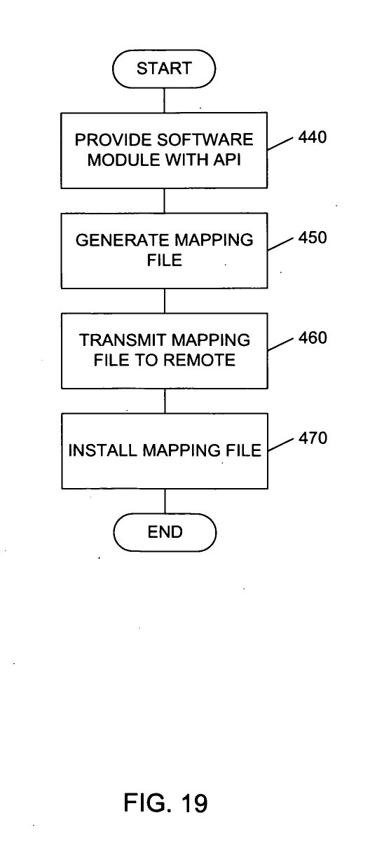

An exemplary method is illustrated in FIG. 19. In this embodiment, flow begins in block 440 where the server 20 provides a software module with an API. As described above, the software module allows a game programmer to specify a controller mapping. Flow continues to block 450 where a mapping file is generated for a particular game. Flow then continues to block 460 where the mapping file is sent to a remote computing apparatus. In block 470 the mapping filed is installed on the remote computing apparatus. When game play is initialized on remote computing apparatus 540, signals received from universal controller 80 are mapped to the appropriate actions within the game.

One feature of this embodiment is that it provides a method that includes providing a software module 410 on a server 20, the software module having an application program interface 820, the software module 410 configured to allow a game programmer to specify a controller mapping. Software module 410 then generates a mapping file 420, from the software module, the mapping file 420 specifying a mapping of actions on a universal controller 80, to a game developed by the game programmer. As described above, server 20 then transmits the mapping file 420 to a remote computing apparatus 540 across a network 10, the remote computing apparatus 540 configured to operate with a universal controller 80. The mapping file 420 is then installed on the remote apparatus 430. The mapping file 420 configures the computing apparatus 540 to map signals received from the universal controller 80 to actions within a game displayed on a display on the display 430 computing apparatus 540. This allows a game programmer to release new games to the public without the need for new controllers. By utilizing the provided software module, universal controller can be remapped to the requirements of the new game.

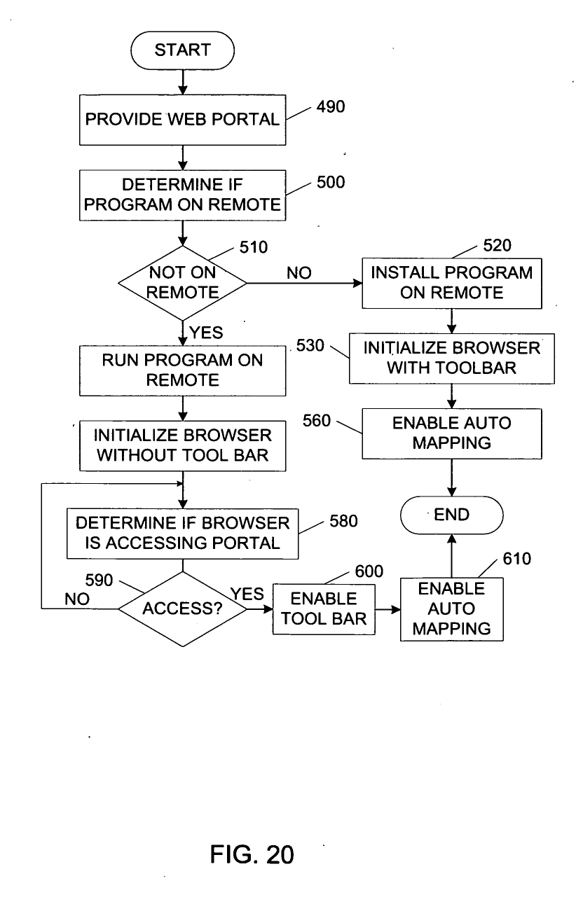

A further provided method is illustrated in FIG. 20. In this embodiment, flow begins with block 490 where a web portal is provided on a server 20. The web portal is configured to provide a web page to remote computing apparatus 540 across network 10. Flow continues to block 500 where server 20 determines if software application 480 has been installed on remote computing apparatus 500. Flow continues to conditional block 510. If software application 480 is not installed on remote computing apparatus 540, flow continues to block 520 where software application 540 is downloaded and installed on remote computing apparatus 540. When software program 480 is executed on remote computing apparatus 530 a web browser is initialized in block 530. in one embodiment in the first instance of browser initialization by software application 480 the browser is initialized with a toolbar enabled. In this embodiment, the enabled tool bar contains a plurality of game selections. Flow continues to block 560 where auto mapping of mapping files 420 is enabled.

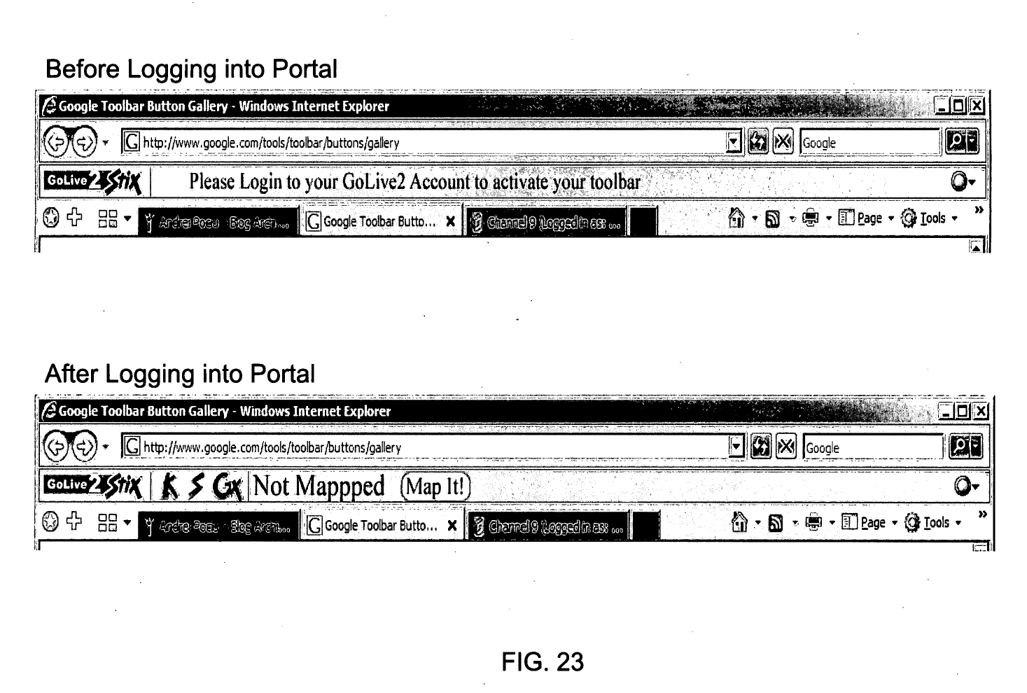

Returning to decision block 510 if it is determined that software application 480 has been installed on remote computing apparatus 540, flow continues to block 550. When software program 480 is initializes it is executed in block 550. Flow continues to block 570 where software program 570 initializes a web browser with a tool bar disabled. Flow then continues to block 580 where server 20 determines if the web browser is accessing the web portal. If, in decision block 590 it is determined that the web browser is not accessing the web portal flow continues back to block 580 and waits until the web browser is accessing the web portal. If in decision block 590 it is determined that web browser is accessing the portal, flow continues to block 600 where the tool bar is enabled. Flow then continues to block 610 where auto mapping of mapping files 420 is enabled. an exemplary web browser with a tool bar is illustrated in FIG. 23.

Methods of providing a web portal are known in the art. An exemplary method includes running web server software, such as Apache web server on a computing apparatus. Various embodiments of software application were developed in JAVA™ programming language, but the present invention is not limited to JAVA™. Those of ordinary skill in the art know that any computer programming language can be used to develop software application 480. For example, C or C++. There are a number of Integrated Development Environments (IDEs) that are advantageous for the development. An exemplary IDE is Visual C++ which allows a programmer to utilize web browser objects within the program. Further, when installing a software program, methods known in the art allow for a program to write a flag to a registry file and to communicate the presence of this flag to a remote server. Thus allowing the server to detect whether a particular software program has been installed on the remote computing apparatus. Other known methods of detection may include the installer asking a user to register the software during installation. This registration communicated to the server. Other installers can be created that do not prompt the user for permission to register, merely inform the server that the software program has been installed. Further, methods of determining if a web server is communicating with a particular computing apparatus are known. Exemplary methods include identification by the server of the remote computing apparatus' Internet Protocol (IP) address.

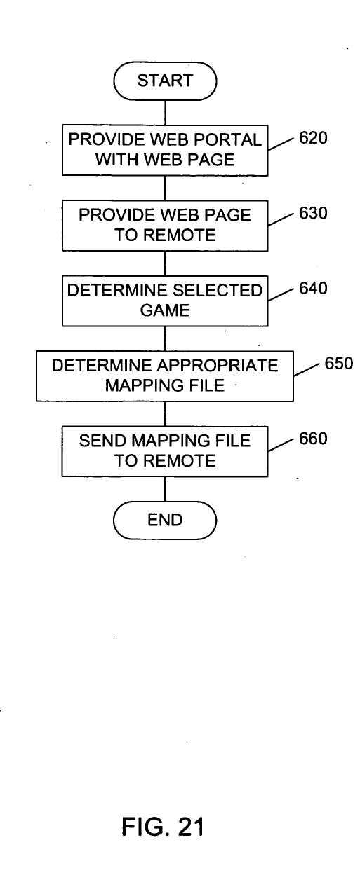

Turning now to FIG. 21 which illustrates the flow of an alternate embodiment of a provided method. In this method, flow begins in block 620 where a server 20 provides a web portal containing at least one web page. As is known in the art, web pages may be created in, for example the Hyper Text Mark-up Language (HTML) or any other similar web based language known to skilled artisans. Further, web portals typically communicate using the Hyper Text Transfer Protocol (HTTP), other protocols for computer communication are known in the art and some embodiments are not therefore limited to either HTML or HTTP. Flow continues to block 630 where the web portal provides a web page to the remote computing apparatus 540. In this embodiment, the webpage comprises a document written in a standard web format, such as html, that includes a number of links. Each of the links indicating a different game to be played. When a link is selected, flow continues to block 640 where server 20 determines which game has been selected. Flow then continues to block 650 where the appropriate mapping file 420 is selected. Flow then continues to block 660 where the mapping file 420 is sent to remote computing apparatus 540.

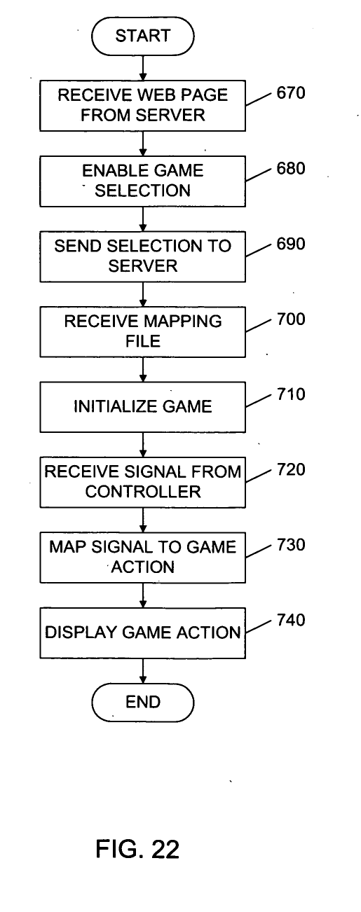

Another embodiment of a provided method is illustrated in FIG. 22. In this method, flow begins in block 670 where a remote computing apparatus 540 receives a web page from server 20. Flow then continues to block 680 where game selection is enabled by the received webpage. Flow then continues to block 690 where, once selected, a game selection is sent to server 20. In block 700 a mapping file is received from server 20. Once the mapping file has been installed, flow continues to block 710 where the selected game is initialized. Flow then continues to block 720 where a signal is received from a universal controller 80. In block 730 the received signal is mapped to a game action. Flow continues to block 740 where the mapped action is displayed on display 430.

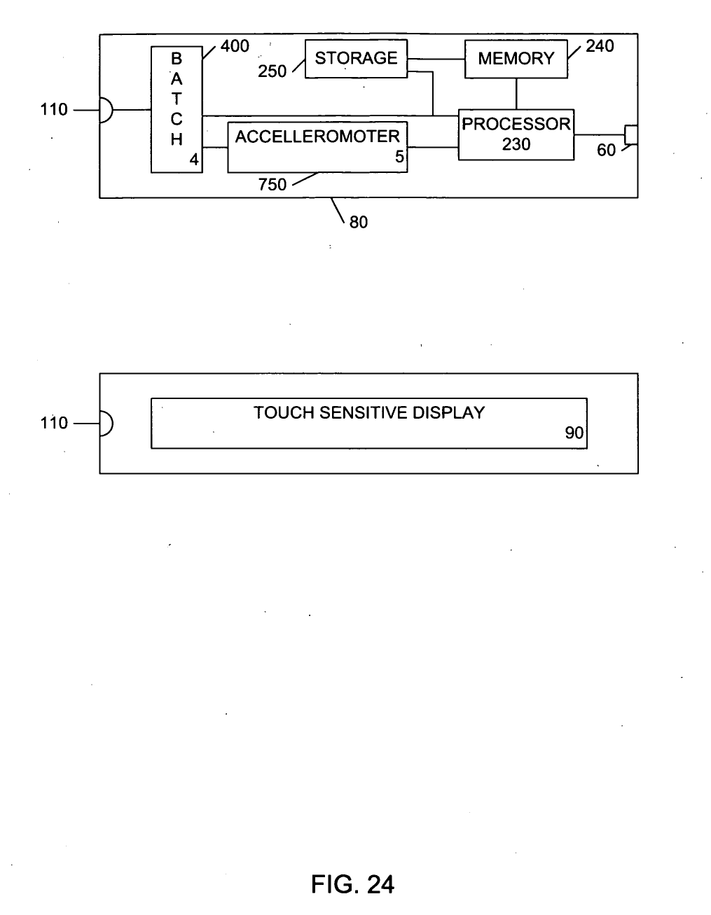

An alternate embodiment of universal controller 80 is illustrated in FIG. 24. In this embodiment, universal controller 80 contains a communications transceiver 60 enabled to send signals to a computing apparatus 540 and, in some embodiments, receive signals from remote computing apparatus 540. As illustrated, this embodiment additionally contains processor 230, memory 240, storage media 250, a plurality of accelerometers 750, battery 400, and battery charging port 110. On the front view controller 80 contains a touch sensitive display 90. In this embodiment, touch sensitive display contains no deformations or tactile areas. Contained within storage media are a set of processor executable instructions, that, when executed by processor 230 cause a bitmap stored in storage media 250 to be mapped and illuminated on touch sensitive display 90. In this manner, universal controller can be updated with additional bitmaps and take on completely different appearance depending on which game is selected fro play.

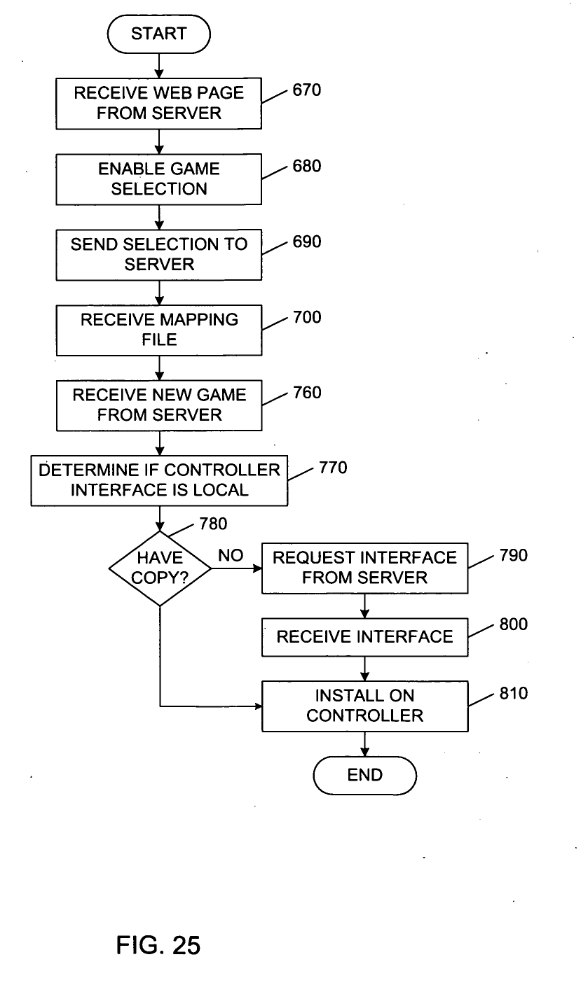

A method for interaction between computing apparatus 540 and universal controller 80 is depicted in FIG. 25. In this embodiment, flow begins in block 670 and continues through block 700 in the manner described above. Flow then continues to block 760 where a new game is received from server 760. In this embodiment, server 20 additionally stores controller interface files (bitmaps) that relate to each game. Flow then continued to block 770 where computing apparatus 540 determines if the appropriate controller interface is on its storage media 250. If, in decision block 780 it is determined that the file is not present locally, flow continues to block 790 where the appropriate interface is requested from server 20. Flow then continues to block 800 where the interface file is received from server 20. Flow then continues to block 810 where the interface file is sent to universal controller 80 and installed. Returning to decision block 780, it is determined that the correct interface file is on computing apparatus' storage media flow continues to block 810 where it is sent to universal controller 80 and installed. In an alternate embodiment (not shown) when a new game is received from server 20 a message is sent to universal controller 80 indicating the game to be played and the version of the interface file. If the appropriate file is stored within universal controller's storage medium 250 the file is not sent from computing apparatus 540. If the file is not on universal controller 80, the file is transmitted from computing apparatus 540 and installed on universal controller 80.

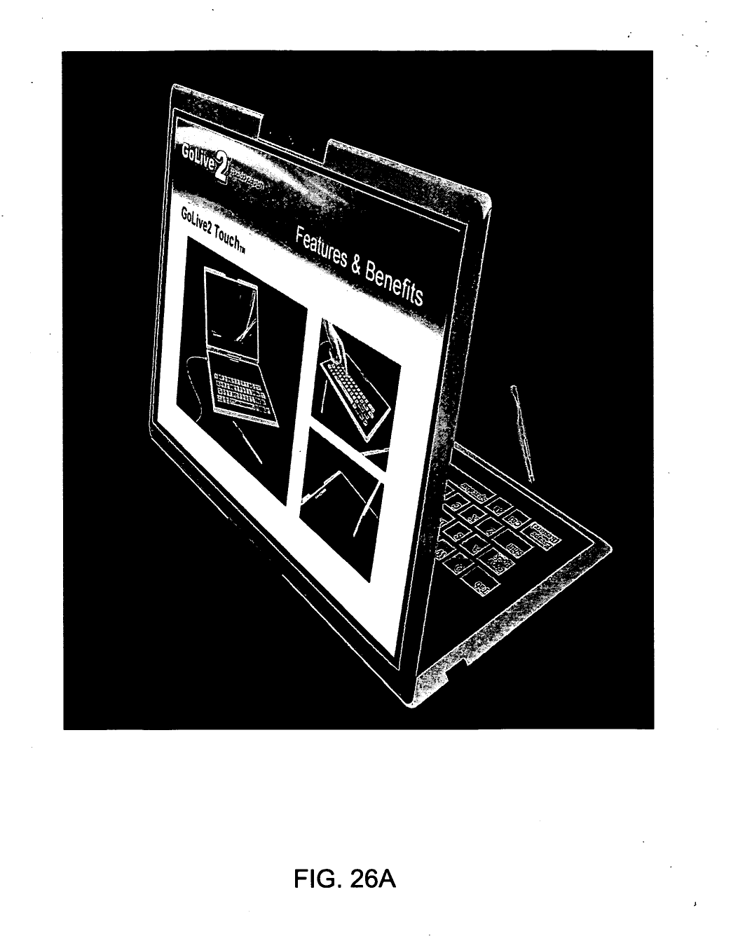

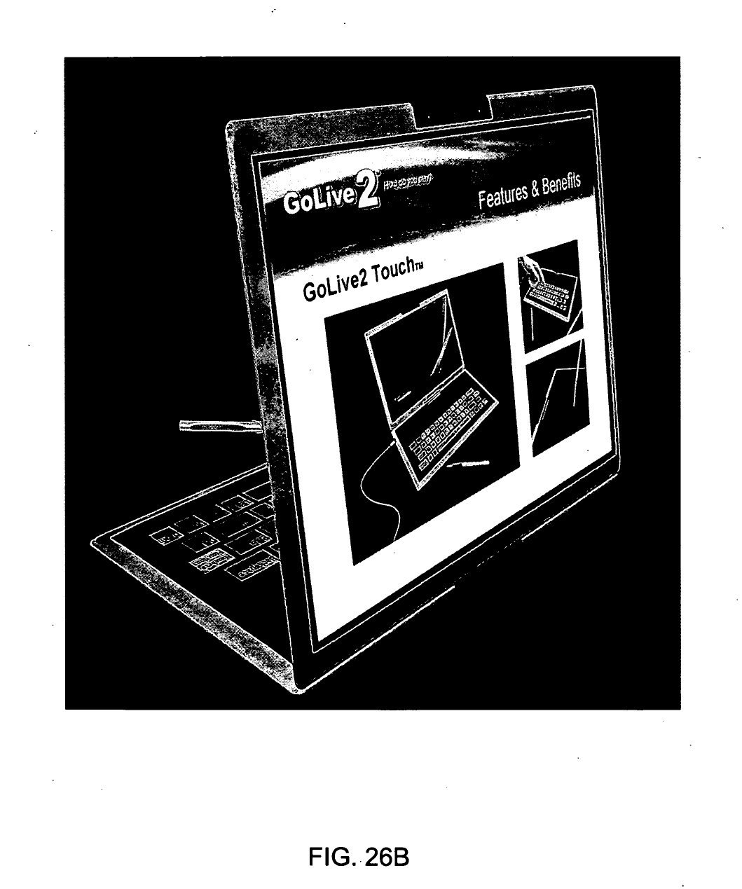

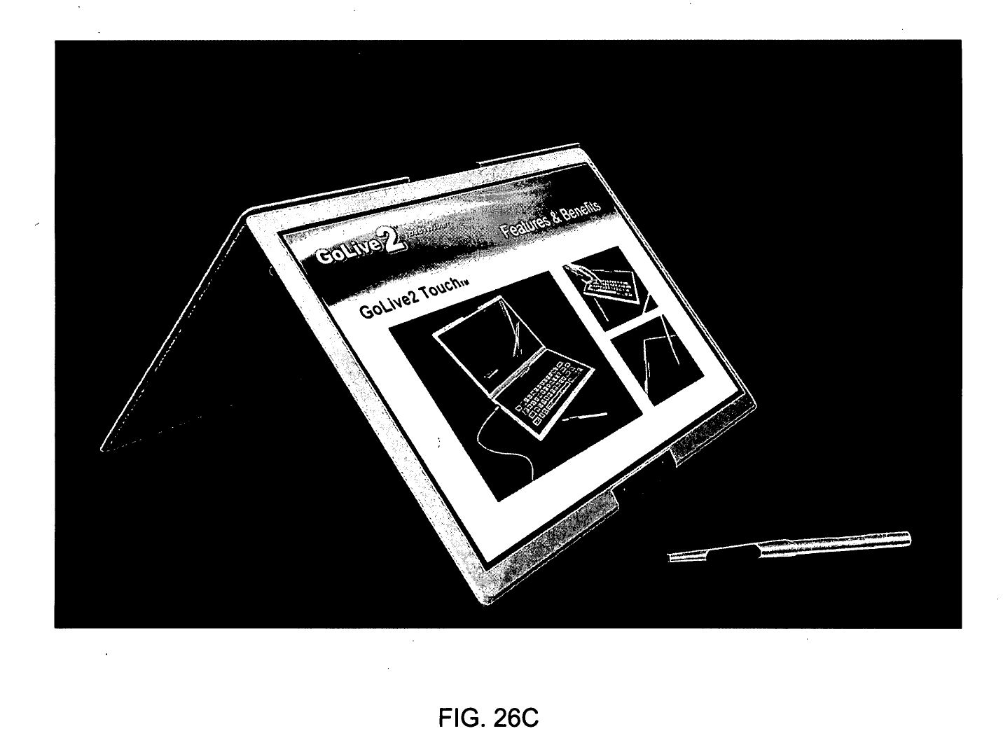

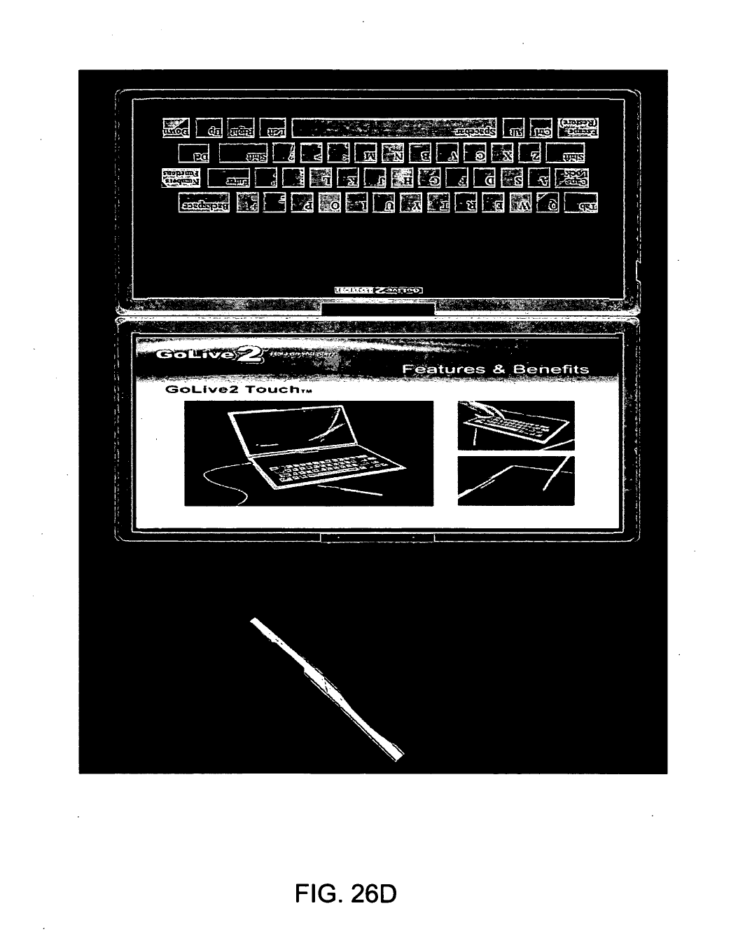

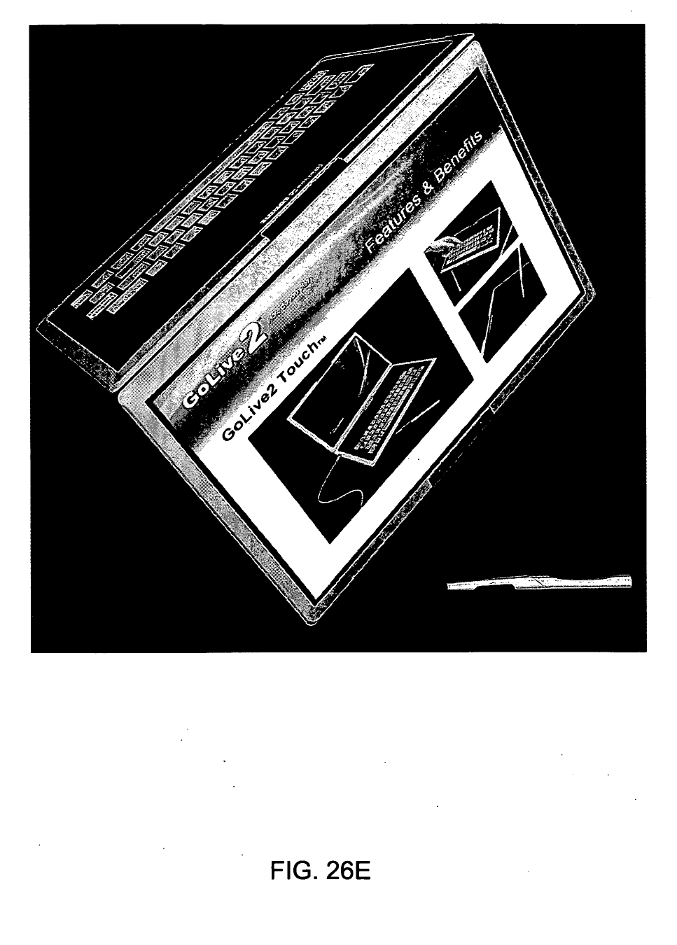

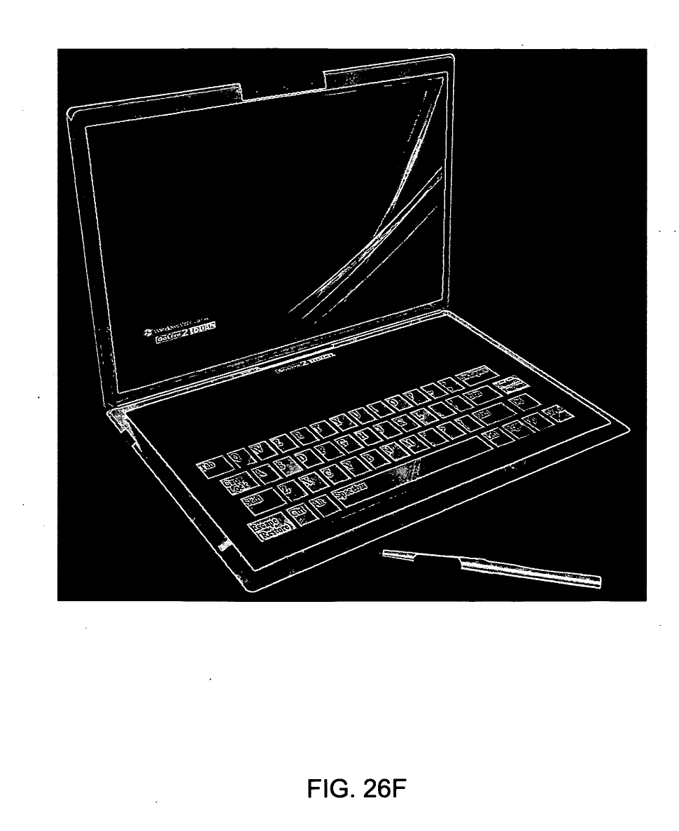

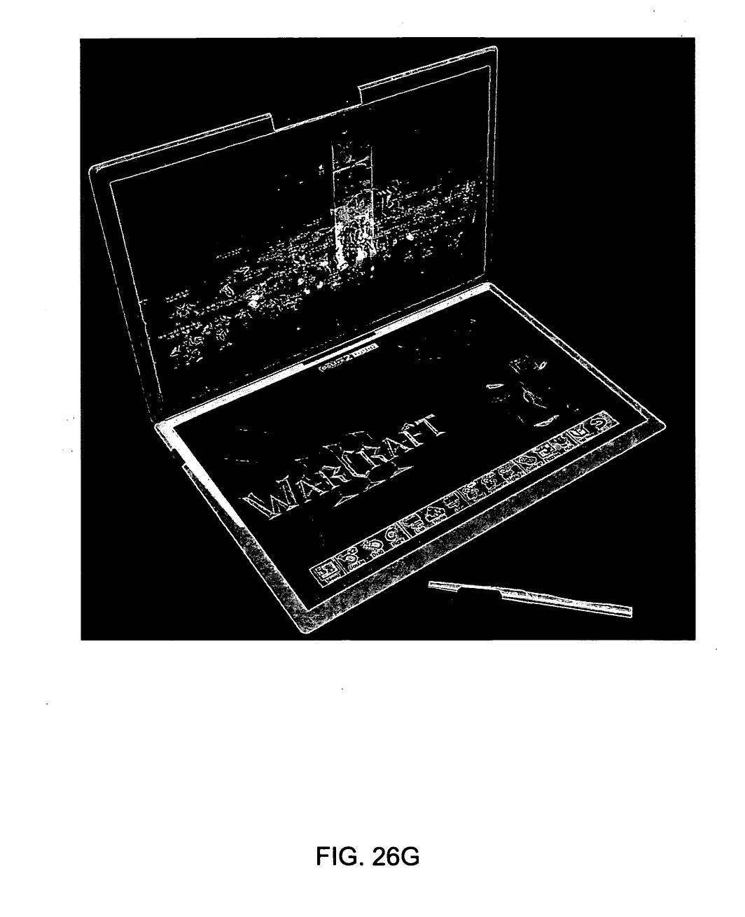

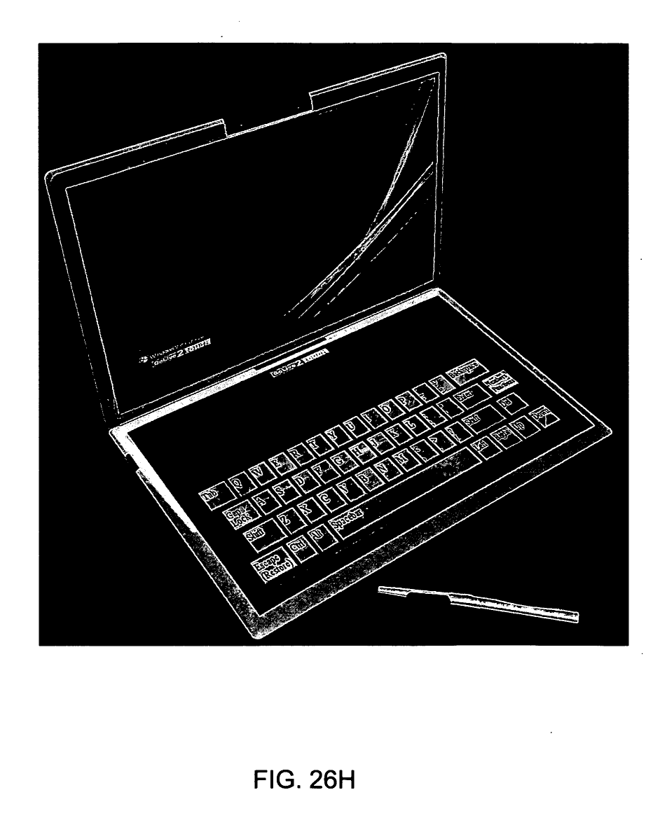

Various embodiments of a provided computing apparatus are illustrated in FIGS. 26 (a)-(h). In these embodiments, at least one, and in some instances two touch screen displays are used. As illustrated, some embodiments of the computing apparatus are connected in a manner to allow a wide range of movement between the displays A central feature of these embodiments, is that the computing apparatus is configured with a set of instructions that when executed by a processor contained within the apparatus, different regions of the display(s) are mapped to different functions. For example, as seen in FIG. 26 (H), a region of the display is configured as a keyboard, and that region is mapped to the functionality of a keyboard In other situations, illustrated in FIG. 26 (G) the same region is illuminated as a game control region and is mapped to receive inputs from a stylus.

Embodiments of the software present on the computing apparatus have been reduced to practice using JAVA™ programming language. Other languages, such as C or C++ are known in the art and some embodiments are not limited to the particular programming language used to implement the functionality described. Further, one of ordinary skill, given this disclosure, will know how to make and use the invention, because graphics rendering, region mapping, and interaction with computer input peripherals are all within the knowledge of a skilled artisan.

Thus, it is seen that an online entertainment system, universal controller system, methods and computer software product are provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. A computing device accessory comprising:
a housing;
a touch sensitive display mounted on the housing;
a communications transceiver; and
a memory contained within the housing and communicating with the touch sensitive display, the memory containing instructions that, when executed by a processor configure the accessory to illuminate discrete regions on the display, the regions comprising: a keyboard region, a stylus sensitive region, and a mouse region.

2. The accessory of claim 1, wherein the instructions further comprise instructions to map a character set to discrete portions of the keyboard region and to configure the accessory to transmit, from the transceiver, a character mapped to a specific discrete region when the discrete region is activated.

3. The accessory of claim 2, wherein the character set is compliant with the American Standard for Information Interchange character set.

4. The accessory of claim 1, wherein the instructions further comprise instructions to configure the accessory to record data related to an interaction with a stylus in the stylus sensitive region.

5. The accessory of claim 4, wherein the instructions further comprise instructions to transmit the data from the transceiver.

6. The accessory of claim 1, wherein the discrete regions further comprise a game control region and the instructions further comprise instructions to illuminate discrete positions of the game control region and to map a plurality of controls to discrete portions of the game control region.

7. The accessory of claim 6, wherein the controls are selected from a group consisting of directional controls, speed controls, and push button controls.

8. The accessory of claim 1, wherein the instructions further comprise instructions to illuminate the mouse control region and record data related to interaction with the mouse control region.

9. The accessory of claim 8 wherein the instructions further comprise instructions to transmit, the data from the transceiver.

10. The accessory of claim 1, wherein the transceiver is selected from a group consisting of a wireless communications transceiver, a wired communications transceiver, an optical communications transceiver, a Universal Serial Bus transceiver, and a RFID transceiver.

11. The accessory of claim 1, further comprising a battery within the accessory providing power to the accessory.

12. The accessory of claim 11, further comprising a communication port connected to the communications transceiver and the battery, the communication port configured to provide power to recharge the battery and to send and receive communications signals.

13. The accessory of claim 12, wherein the communications port is a Universal Serial Bus port.

14. The accessory of claim 1, further comprising a communication port connected to the communications transceiver, the communication port configured to provide power to the accessory and to send and receive communications signals.

15. The accessory of claim 14, wherein the communication port is a Universal Serial Bus port.

16. A computing apparatus comprising:
a processor;
a memory;
a touch sensitive display; and
a storage media the storage media comprising a set of processor executable instructions sufficient that, when executed by the processor, configure the computing apparatus to illuminate discrete regions on the display, the regions comprising: a keyboard region, a stylus sensitive region, and a mouse region.

17. The computing apparatus of claim 16, wherein the instructions further comprise instructions to map a character set to discrete portions of the keyboard region.

18. The computing apparatus of claim 17, wherein the character set is compliant with the American Standard for Information Interchange character set.

19. The computing apparatus of claim 18, wherein the instructions further comprise instructions to configure the accessory to record data related to an interaction with a stylus in the stylus sensitive region.

20. The computing apparatus of claim 16, wherein the discrete regions further comprise a game control region and the instructions further comprise instructions to illuminate discrete positions of the game control region and to map a plurality of controls to discrete portions of the game control region.

21. The computing apparatus of claim 20, wherein the controls are selected from a group consisting of directional controls, speed controls, and push button controls.

22. The computing apparatus of claim 16, wherein the instructions further comprise instructions to illuminate the mouse control region and record data related to interaction with the mouse control region.

23. A method of providing interaction with a computing apparatus comprising:
illuminating discrete regions on a touch sensitive display, the touch sensitive display mounted on a housing, the housing comprising a memory, the discrete regions comprising a keyboard region, a stylus sensitive region, and a mouse region.

24. The method of claim 23, further comprising mapping a character set to discrete portions of the keyboard region, the housing further comprising a communications transceiver the method further comprising transmitting, from the communications transceiver a character mapped to a specific discrete region when the discrete region is activated.

25. The method of claim 24, wherein the character set is compliant with the American Standard for Information Interchange character set.

26. The method of claim 23, further comprising recording data related to an interaction with a stylus in the stylus sensitive region.

27. The method of claim 26, further comprising transmitting the data from the transceiver.

28. The method of claim 23, wherein the discrete regions further comprise a game control region and the method further comprises illuminating discrete portions of the game control region and mapping a plurality of controls to discrete portions of the game control region.

29. The method of claim 28, wherein the controls are selected from a group consisting of directional controls, speed controls, and push button controls.

30. The method of claim 23, further comprising illuminating the mouse control region and recording data related to interaction with the mouse control region.

31. The method of claim 30 wherein further comprising transmitting the data from the transceiver.

32. The method of claim 23, wherein the transceiver is selected from a group consisting of a wireless communications transceiver, a wired communications transceiver, an optical communications transceiver, a Universal Serial Bus transceiver, and a RFID transceiver.

33. The method of claim 23, wherein the housing further comprises a battery.

34. The method of claim 33, wherein the housing further comprises a communication port connected to the communications transceiver and the battery, the communication port configured to provide power to recharge the battery and to send and receive communications signals.

35. The method of claim 35, wherein the communications port is a Universal Serial Bus port.

36. The method of claim 23, wherein the housing further comprises a communication port connected to the communications transceiver, the method further comprising providing power from the communications port to the display and providing power from the communications port to the communications transceiver.

37. The method of claim 36, wherein the communication port is a Universal Serial Bus port.

38. A computer implemented method comprising:
providing a computing apparatus, the computing apparatus comprising:
a processor;
a memory; and
a touch sensitive display;
illuminating discrete regions on the display, the regions comprising: a keyboard region, a stylus sensitive region, and a mouse region.

39. The method of claim 38, further comprising mapping a character set to discrete portions of the keyboard region and to configure the accessory to transmit, from the transceiver, a character mapped to a specific discrete region when a corresponding illuminated discrete region is activated.

40. The method of claim 39, wherein the character set is compliant with the American Standard for Information Interchange character set.

41. The method of claim 38, further comprising instructions to configuring the accessory to record data related to an interaction with a stylus in the stylus sensitive region.

42. The method of claim 38, wherein the discrete regions further comprise a game control region and the method further comprises illuminating discrete positions of the game control region and mapping a plurality of controls to discrete portions of the game control region.

43. The method of claim 42, wherein the controls are selected from a group consisting of directional controls, speed controls, and push button controls.

44. The method of claim 38, further comprising illuminating the mouse control region and recording data related to interaction with the mouse control region.

45. A computer software product comprising:
a machine readable media, the machine readable media containing instructions that when executed by a processor illuminate discrete regions on a touch sensitive display, the regions comprising: a keyboard region, a stylus sensitive region, and a mouse region.

46. The software product of claim 45, wherein the instructions comprise instructions to map a character set to discrete portions of the keyboard region.

47. The software product of claim 46, wherein the touch sensitive display is connected to a communications transceiver, the instructions further comprising instructions to configure the transceiver to transmit a character mapped to a specific discrete region when the discrete region is activated.

48. The software product of claim 47, wherein the transceiver is selected from a group consisting of a wireless communications transceiver, a wired communications transceiver, an optical communications transceiver, a Universal Serial Bus transceiver, and a RFID transceiver.

48. The software product of claim 46, wherein the character set is compliant with the American Standard for Information Interchange character set.

49. The software product of claim 45, wherein the instructions further comprise instructions to record data related to an interaction with a stylus in the stylus sensitive region.

50. The software product of claim 48, wherein the touch sensitive display is connected to a communications transceiver, the instructions further comprising instructions to transmit the data from the transceiver.

51. The software product of claim 50, wherein the transceiver is selected from a group consisting of a wireless communications transceiver, a wired communications transceiver, an optical communications transceiver, a Universal Serial Bus transceiver, and a RFID transceiver.

52. The software product of claim 45, wherein the discrete regions further comprise a game control region and the instructions further comprise instructions to illuminate discrete positions of the game control region and to map a plurality of controls to discrete portions of the game control region.

53. The software product of claim 52, wherein the controls are selected from a group consisting of directional controls, speed controls, and push button controls.

54. The software product of claim 45, wherein the instructions further comprise instructions to illuminate the mouse control region and record data related to interaction with the mouse control region.

55. The software product of claim 54, wherein the touch sensitive display is connected to a communications transceiver, the instructions further comprising instructions to transmit the data from the transceiver.

56. The software product of claim 55, wherein the transceiver is selected from a group consisting of a wireless communications transceiver, a wired communications transceiver, an optical communications transceiver, a Universal Serial Bus transceiver, and a RFID transceiver.
